(19) United States
(12) Patent Application Publication
(10) Pub. No.: US 2007/0143188 A1
(43) Pub. Date: Jun. 21, 2007

(54) SYSTEM AND METHOD FOR PROCESSING ITEMS PLACED IN A CONTAINER

(75) Inventors: Edward E. Kelley, Wappingers Falls, NY (US); Tijs Wilbrink, Leiden (NL)

Correspondence Address: HOFFMAN, WARNICK & D'ALESSANDRO LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 11/306,076

(22) Filed: Dec. 15, 2005

(51) Int. Cl. G06Q 30/00

(52) U.S. Cl. 705/26

(57) ABSTRACT

A system and method for processing items placed in a container. The system includes a cart having a system for processing items stored therein, comprising: a detection system that detects the placement of an item into the cart; a near field communication (NFC) reader for reading and storing information from an NFC tag attached to items detected as being placed in the cart.

### BACKGROUND OF THE INVENTION

1. Technical Field

The present invention relates generally to a system and method for processing items placed in a container, and more specifically relates to a system and method for using near field communication (NFC) technology to read items placed in a shopping cart.

2. Related Art

There have been numerous attempts to process items placed in shopping carts using radio frequency identification (RFID) tags and readers. Unfortunately, current approaches using RFID tags are problematic in that 100 percent of the items placed in the cart are not always properly identified and processed. Because of this, the use of this type technology for a shopping cart application has not been widely deployed. There are various reasons why the current approaches do not work, but the end result is unacceptable if items are not paid for.

A further problem with RFID devices on the shopping carts is that that RFID readers have a range such that passing close to a shelf can cause the RFID reader to read some of the shelf items and create an error as the number of items in the cart are tracked. Accordingly, a need exists for a system and method for processing items placed in a container in which a high level of confidence is provided that all items in the container have been properly accounted for.

### SUMMARY OF THE INVENTION

The present invention addresses the above-mentioned problems, as well as others, by providing a system and method for using near field communication (NFC) technology to read items placed in a shopping cart. In addition to NFC, the present invention utilizes a set of light sensitive cells in the shopping cart to act as a check on the reader. Whenever the light beam between the light sensitive cells is broken, a counter is advanced to indicate that there is an item that has to be accounted for.

In a first aspect, the invention provides a cart having a system for processing items stored therein, comprising: a detection system that detects the placement of an item into the cart; a near field communication (NFC) reader for reading and storing information from an NFC tag attached to items detected as being placed in the cart.

In a second aspect, the invention provides a method of processing items placed in a cart, comprising: activating a processing system associated with the cart; detecting an item being placed in the cart with a detection mechanism; reading information from a tag attached to the item with a near field communication (NFC) reader; and storing the information read from the tag.

In a third aspect, the invention provides a method of automatically processing items placed in a shopping cart, comprising: activating a processing system associated with the shopping cart when a user begins shopping; tripping a light sensor each time an item is placed in the shopping cart; reading information from a tag attached to an item with a near field communication (NFC) reader whenever the light sensor is tripped; storing the information read by the NFC reader in memory; notifying the processing system that the user is done shopping; polling all items in the shopping cart to determine an inventory; comparing the inventory with the stored information; and effectuating a checkout procedure.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a cart having an item processing system in accordance with the present invention.

FIG. 2 depicts a flow chart depicting a method of implementing an item processing system in accordance with the present invention.

### DETAILED DESCRIPTION OF THE INVENTION

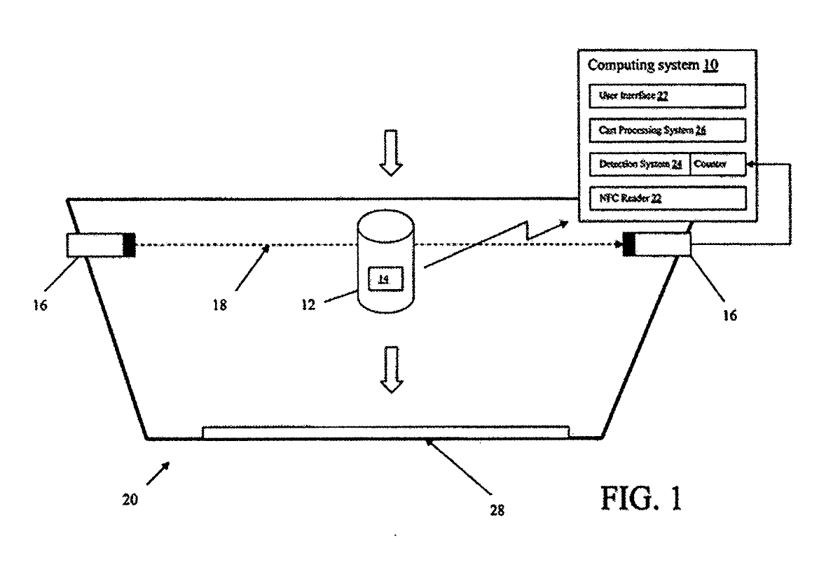

Referring now to drawings, FIG. 1 depicts a cart 20 equipped to process items placed in the cart 20. In this illustrative embodiment, cart 20 includes a computing system 10 comprising: an NFC (near field communication) reader 22 for reading information from an item 12 placed in the cart 20, a detection system 24 for detecting when an item 12 is placed in or removed from the cart 20, a cart processing system 26 for storing and communicating information about items in the cart 20, and a user interface 27 (such as a graphical user interface or key pad) for allowing a user to interact with the computing system 10, including entering commands, reading information, making payments, etc. In this embodiment, detection system 24 also includes a detection mechanism comprised of a set of light sensors 16 that are triggered whenever an object breaks the light beam 18. Obviously, the number and arrangement of light sensors can vary without departing from the scope of the invention. In addition, other types of detection mechanisms, e.g., a weight sensor or scale 28 at the bottom of the cart 20, could likewise be utilized within the scope of the invention. It should also be appreciate that cart 20 may comprise any type of container suitable for holding items, including, but not limited to shopping carts.

Included with each item 12 is an NFC tag 14, which is capable of storing information that can be read by NFC reader 22. Similar to radio frequency identification (RFID), NFC transmits information via inductive electromagnetic coupling in the radio frequency portion of the spectrum. NFC adheres to a standard recently ratified that specifies transfer speeds up to 424 kilobits per second operating at a frequency of 13.56 megahertz. NFC offers a much shorter range than the (RFID) technology on which the new standard is based. Namely, NFC is limited to a range of about 10 centimeters, instead of two to five meters common in RFID.

With a range of just 10 centimeters, NFC can get by with a very small, low-cost radio transmitter that requires very little power. In a supermarket setting, or the like, the limited range reduces the risk that the NFC reader 22 will inadvertently read items on the shelf. Accordingly, its small transmission range helps to ensure security.

Another advantage of NFC over RFID is that when two NFC devices are moved next to each other, a connection is established immediately. A key difference between NFC and other forms of wireless communications is that NFC adds software that enables instant setup of peer-to-peer (P2P) networking. As with P2P wireless communications between Bluetooth enabled devices, NFC devices automatically seek each other out and establish a communications link. (Note that the popular Wi-Fi wireless networking technology is different, as it requires an access hub.) This P2P approach also differs from RFID networks, which are set up in a master/slave relationship in which passive chips are read by expensive, powered “reader” devices. NFC devices, on the other hand, can be set to either passive or active mode, so they can send identification data even when the device is turned off (passive mode), making them ideal for smart card applications.

NFC can initiate a communications session quickly and has very fast and easy configuration and pairing. By comparison, Bluetooth, which is also designed to exchange data between devices in close proximity, requires tedious setup procedures between communicating devices.

As noted, when the item 12 is placed into the cart 20, it breaks the light beam 18, which tells detection system 24 that a new item 12 has been placed in the cart that is ready to be read by NFC reader 22. Detection system 24 may include a counter that keeps track of the number of items in the cart. NFC reader 22 stores the information from each item in memory. Once item 12 has been successfully detected by detection system 24 and read by NFC reader 22, cart processing system 26 can perform any number of functions. For instance, cart processing system 26 can: analyze information on any items currently stored in the cart; poll (i.e., provide an inventory of) items in the cart 20; verify what is stored in memory by comparing stored information with the inventory; display information to the user about what is in the cart 20; communicate information to a cashier for checkout and payment processing; etc.

In general, computing system 10 may comprise any type of computer system, and could be implemented as part of a client and/or a server. Computing system 10 generally includes a processor, input/output (I/O), memory, and a bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. The bus provides a communication link between each of the components in the computing system 10 and likewise may comprise any known type of transmission link, including electrical, optical, wireless, etc. Although not shown, additional components, such as cache memory, communication systems, system software, etc., may be incorporated into computing system 10.

Access to computing system 10 may be provided over a wireless network such as the Internet, a local area network (LAN), a wide area network (WAN), a virtual private network (VPN), etc. Communication could occur via any combination of wireline and wireless transmission methods. Further, as indicated above, communication could occur in a client-server or server-server environment.

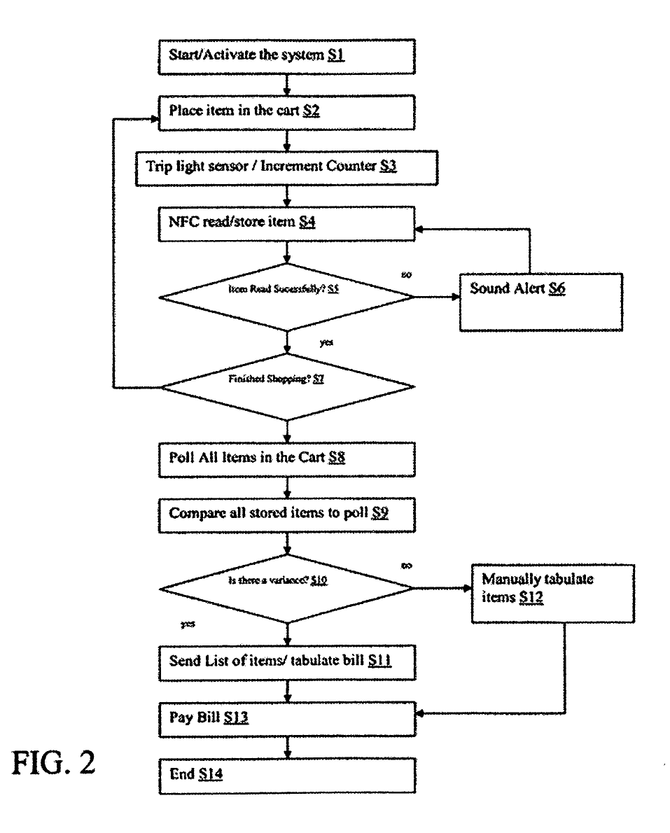

Referring now to FIG. 2, a flow chart of a method for processing items within a cart 20 for use during shopping is shown. At step S1, the process is started with the system being activated. This may for example occur when a customer takes possession of a shopping cart or presses a button on a control pad attached to the cart 20. At step S2, an item is placed in the cart 20 and at step S3 a light sensor (or other detection mechanism) is tripped, which increments a counter and tells the system that an item is ready to be read. At step S4, an NFC reader reads the item and stores the information about the item. At step S5, a check is made to see if the item was read successfully. If not, then an alarm is sounded at step S6 and a further attempt is made to read the item at step S4.

Next, at step S7 a check is made to see if the user is finished shopping. This may be indicated when the user presses a button on the control pad, moves toward an exit, etc. If the user is not finished, then control returns to step S2, where the user can place additional items in the cart 20. If the user is finished, then a poll of all the items in the cart is taken to determine an inventory at step S8 and at step S9 the inventory is compared to the stored information (obtained when the items were originally placed in the cart 20). At step S10, a check is made to see if there is a variance. If there is no variance, then at step S11 a list of the items is communicated, e.g., wirelessly, to a cashier where a bill is tabulated. At step S13, the bill is paid, e.g., at a kiosk, at the key pad on the cart, via a smart card, etc., and at step S14 the process ends. If there is a variance at step S10, then the cart 20 can be brought to a cashier where at step S12 the items can be manually tabulated and then paid for at step S13.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A cart having a system for processing items stored therein, comprising: a detection system that detects the placement of an item into the cart; a near field communication (NFC) reader for reading and storing information from an NFC tag attached to items detected as being placed in the cart.

2. The cart of claim 1, wherein the detection system comprises a set of light sensors.

3. The cart of claim 1, wherein the detection system comprises a weight sensor.

4. The cart of claim 1, further comprising a system for directing the NFC reader to poll all items stored in the cart to determine an inventory of all items in the cart.

5. The cart of claim 4, further comprising a system for comparing the inventory with stored data.

6. The cart of claim 1, wherein the detection system comprises a counter to track a number of items placed in the cart.

7. A method of processing items placed in a cart, comprising: activating a processing system associated with the cart; detecting an item being placed in the cart with a detection mechanism; reading information from a tag attached to the item with a near field communication (NFC) reader; and storing the information read from the tag.

8. The method of claim 7, wherein the detection mechanism comprises a light sensor.

9. The method of claim 7, wherein the detection mechanism comprises a weight sensor.

10. The method of claim 7, comprising the further step of incrementing a counter each time a new item is placed in the cart.

11. The method of claim 7, comprising the further step of performing a test to see if information from the tag was read successfully.

12. The method of claim 11, comprising the further step of sounding an alarm if the information from the tag was not read successfully.

13. The method of claim 7, comprising the further steps of: notifying the processing system that no further items are to be placed in the cart;
polling the items in the cart to generate an inventory; and comparing the inventory to stored information about items placed in the card.

14. The method of claim 13, comprising the further steps of: sending a list of items in the cart to a cashier; and effectuating payment of the list of items.

15. A method of automatically processing items placed in a shopping cart, comprising: activating a processing system associated with the shopping cart when a user begins shopping; tripping a light sensor each time an item is placed in the shopping cart; reading information from a tag attached to an item with a near field communication (NFC) reader whenever the light sensor is tripped; storing the information read by the NFC reader in memory; notifying the processing system that the user is done shopping; polling all items in the shopping cart to determine an inventory; and comparing the inventory with the stored information; effectuating a checkout procedure.

16. The method of claim 15, wherein the step of activating a processing system is done with a user interface to the processing system.

17. The method of claim 15, wherein the tripping step causes a counter to be incremented.

18. The method of claim 15, comprising the further step of performing a test to see if information from the tag was read successfully.

19. The method of claim 18, comprising the further step of sounding an alarm if the information from the tag was not read successfully.

20. The method of claim 15, wherein the comparing step includes effectuating a manual checkout procedure if the inventory does not match the stored information.
